(19) United States
(12) Patent Application Publication
(10) Pub. No.: US 2013/0217534 A1
(43) Pub. Date: Aug. 22, 2013

(54) MULTISPEED TRANSMISSION

(71) Applicant: Johann Kirchhoffer, Koeln (DE)

(72) Inventor: Johann Kirchhoffer, Koeln (DE)

(73) Assignee: FORD GLOBAL TECHNOLOGIES, LLC, Dearborn, MI (US)

(21) Appl. No.: 13/823,292

(22) PCT Filed: Nov. 4, 2011
(86) PCT No.: PCT/EP2011/069379

§ 371 Date: Mar. 14, 2013

(30) Foreign Application Priority Data
Nov. 10, 2010 (DE) 10 2010 043 670.4

(51) Int. Cl. F16H 3/62

(52) U.S. Cl. CPC F16H 3/62
USPC 475/276; 475/296

(57) ABSTRACT

The present invention relates to a multispeed transmission, having an input element (5), an output element (35), a Simpson planetary gearset (30), which has a common sun wheel (S2b, S3), two annuluses (R2b, R3) and two planet carrier arrangements (P2b, P3), and an overdrive planetary gear (10), which has a sun wheel (S1), a planet carrier arrangement (P1) and an annulus (R1) and is connected in series with the Simpson planetary gearset (30). The multispeed transmission furthermore has an underdrive planetary gear (20), which has a sun wheel (S2), a planet carrier arrangement (P2) and an annulus (R2) and is connected in series with the Simpson planetary gearset (30) and the overdrive planetary gear (10).

The present invention relates to a multispeed transmission.

As the development of smaller engines with relatively low fuel consumption has progressed, there has been an ongoing demand for transmissions with an ever larger range of transmission ratios and a large number of speeds as well as as uniform as possible a distribution of the transmission ratios.

U.S. Pat. No. 7,749,126, U.S. Pat. No. 7,731,625 and U.S. Pat. No. 7,736,263 have disclosed multispeed transmissions, each of which employs a Simpson planetary gearset in order to obtain an 8- or 9-speed transmission overall. As is known, a Simpson planetary gearset of this kind has a common sun wheel for two annuluses as well as two planet carrier arrangements.

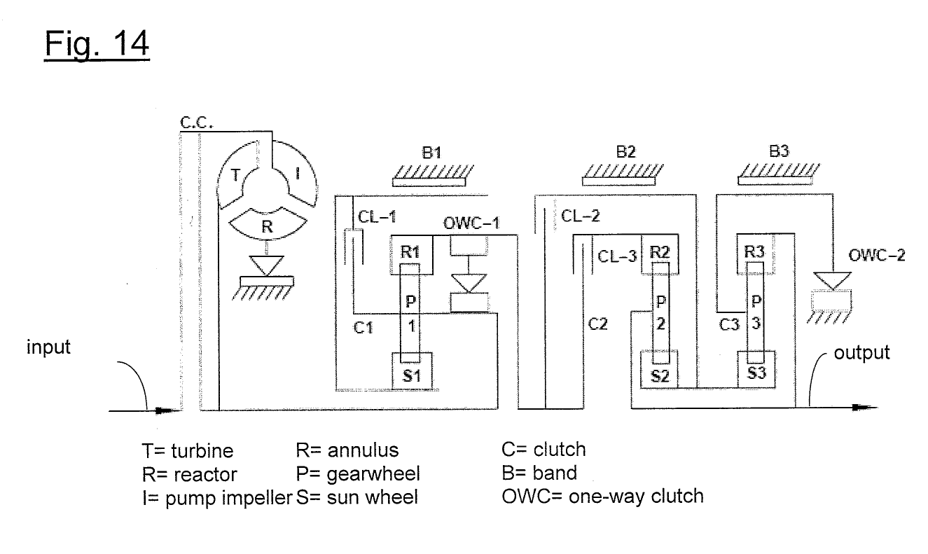

FIG. 14 shows a multispeed transmission of the type in question in accordance with the preamble of claim 1, which is also referred to as a 5R55E transmission. A multispeed transmission of this kind comprises an input element, an output element, a Simpson planetary gearset, which has a common sun wheel, two annuluses and two planet carrier arrangements, and an overdrive planetary gear, which has a sun wheel, a planet carrier arrangement and an annulus and is connected in series with the Simpson planetary gearset.

It is the object of the present invention to provide a multispeed transmission which allows a high degree of flexibility as regards the speeds or transmission ratios that can be selected and as regards variation of the spread.

This object is achieved in accordance with the features of independent patent claim 1.

The multispeed transmission is distinguished by the fact that it furthermore has an underdrive planetary gear, which has a sun wheel, a planet carrier arrangement and an annulus and is connected in series with the Simpson planetary gearset and the overdrive planetary gear.

In particular, the invention is based on the concept of interconnecting a Simpson planetary gearset, an overdrive planetary gear and an underdrive planetary gear in series in such a way that the underdrive planetary gear adds a larger range of transmission ratios to the Simpson planetary gearset. At the same time, two advantages are achieved in the multispeed transmission according to the invention by virtue of the overdrive planetary gear: on the one hand, it is possible - depending on the gear selection ultimately made - to operate the multispeed transmission in the economy ratio.

On the other hand, it is also possible for the transmission ratio of the overdrive planetary gear to be shifted between the transmission ratios of the underdrive planetary gear and the transmission ratios of the Simpson planetary gearset, thereby avoiding large steps or jumps in overall transmission ratios. Overall, the combination according to the invention of an underdrive planetary transmission with an overdrive planetary transmission provides a multispeed transmission which achieves a high degree of flexibility as regards the speeds or transmission ratios which can be selected while simultaneously achieving a large or smaller transmission spread.

Conventional prior art automatic transmissions fitted with planetary gears generally allow geometric transmission jumps. This means that the gear ratio spread in first gear is very high and decreases geometrically in higher gears. This has the disadvantage that there are considerable gaps in acceleration, prejudicing the dynamic response and fuel consumption of the vehicle. In this case, the engine/transmission system does not fully exploit the power characteristic of the engine. Owing to the possibility of connecting and disconnecting the overdrive planetary gear, these gear ratio jumps can be reduced in order to obtain uniform gear ratio jumps or uniform accelerations.

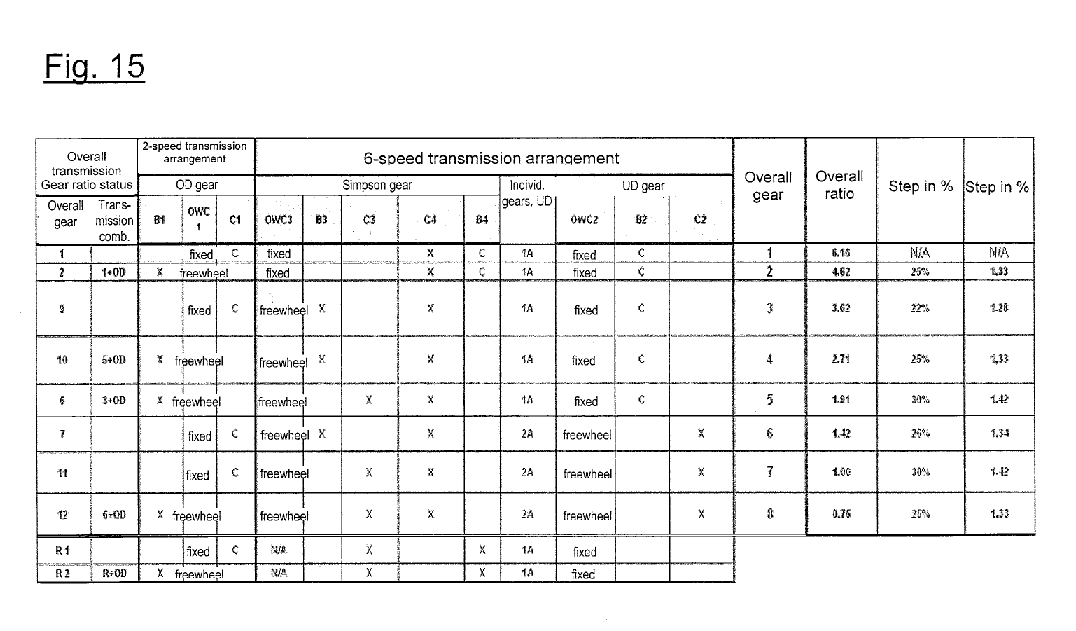

FIG. 15 shows a possible 8-speed transmission having the corresponding gear ratio steps and gear ratio jumps. In this case, the overdrive planetary gear is connected and disconnected four times in order to reduce the abovementioned wide gear ratio jumps. 8^{th} gear is then the pure overdrive gear and is designed as an economy ratio.

According to one embodiment, either the sun wheel or the annulus can be fixed in the underdrive planetary gear. This has the advantage that large or medium transmission spreads can be accomplished.

In this way, a total of 12 different transmission ratios can be achieved. By means of the underdrive planetary gear with either a wide or a medium spread or transmission ratio (depending on whether the sun wheel or the annulus is fixed), it is possible to increase or reduce the overall transmission spread accordingly as a multiplier in order in this way to be able to provide different transmission ratios using the Simpson and the overdrive planetary gearset. In the multispeed transmission according to the invention, the combination of the underdrive planetary gear and the Simpson planetary gearset forms a 6-speed transmission arrangement, wherein the additional series connection with the overdrive planetary gear makes it possible to achieve a multispeed transmission with (in theory) 12 forward gears and 2 reverse gears.

Of these theoretically selectable 12 gears, the multispeed transmission according to the invention makes it possible to select up to 10 actual gears and to provide an overall transmission spread with a value of between 6.0 and 10.0.

It is even possible, by means of appropriate transmission control, to operate the multispeed transmission according to the invention as a 6-speed version or, alternatively, as an 8-, 9- or 10-speed version, without modifying the multispeed transmission physically or performing hardware changes. This has the advantage that the shifting frequency can be correspondingly reduced, something that can be accomplished with a particular engine version or with a special diesel version if necessary.

The multispeed transmission according to the invention can be operated optionally as a 6-speed transmission, 7-speed transmission, 8-speed transmission, 9-speed transmission or 10-speed transmission by means of the transmission control system in a single transmission. On the one hand, this makes it possible to achieve optimum starting characteristics and, at the same time, to minimize the shifting frequency, depending on the driving situation.

The invention furthermore comprises the implementation of the multispeed transmission described above, both within a ‘north-south’ arrangement and in an ‘east-west’ arrangement for vehicles with front wheel drive. The ‘north-south’ arrangement is distinguished by the fact that the underdrive, overdrive and Simpson planetary gearset are arranged on one transmission axis. The ‘east-west’ arrangement or embodiment contains at least two transmission axes, which are arranged in parallel and with which either the overdrive, the underdrive or the Simpson planetary gear are arranged either on the upper transmission axis in series with the starting system or on one of the lower transmission axes in combination with the differential. The individual axes can be connected by means of a transfer gear, either in the form of a gearwheel set or a chain link.

Further embodiments of the invention can be found in the description and in the dependent claims.

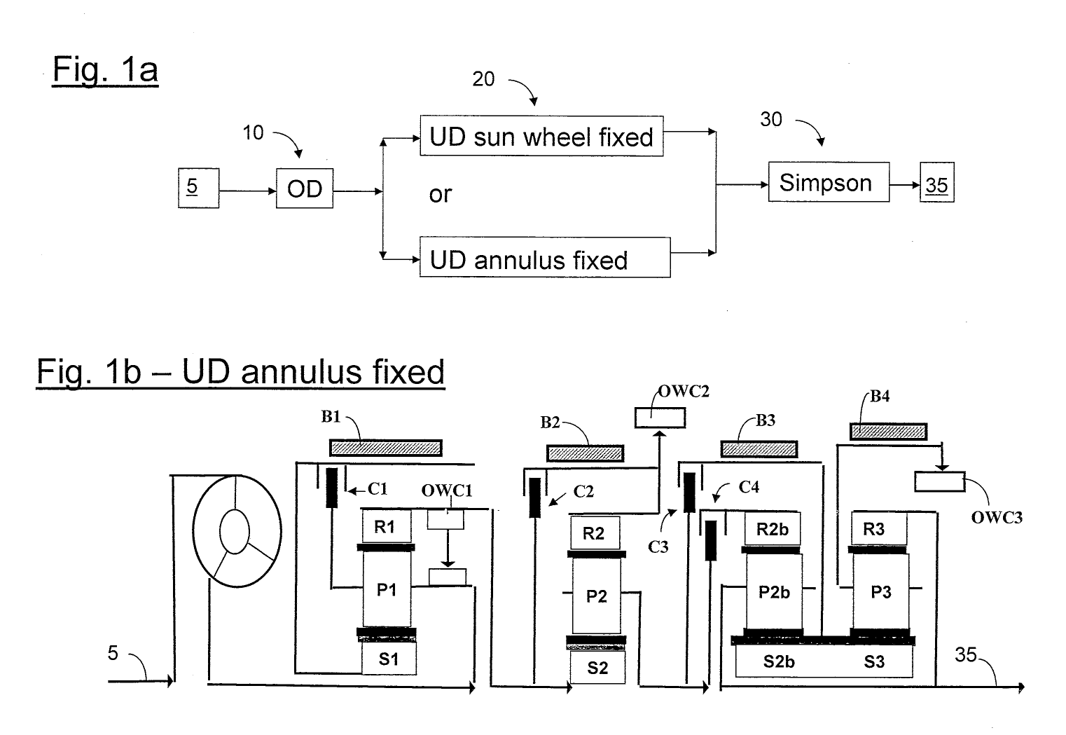

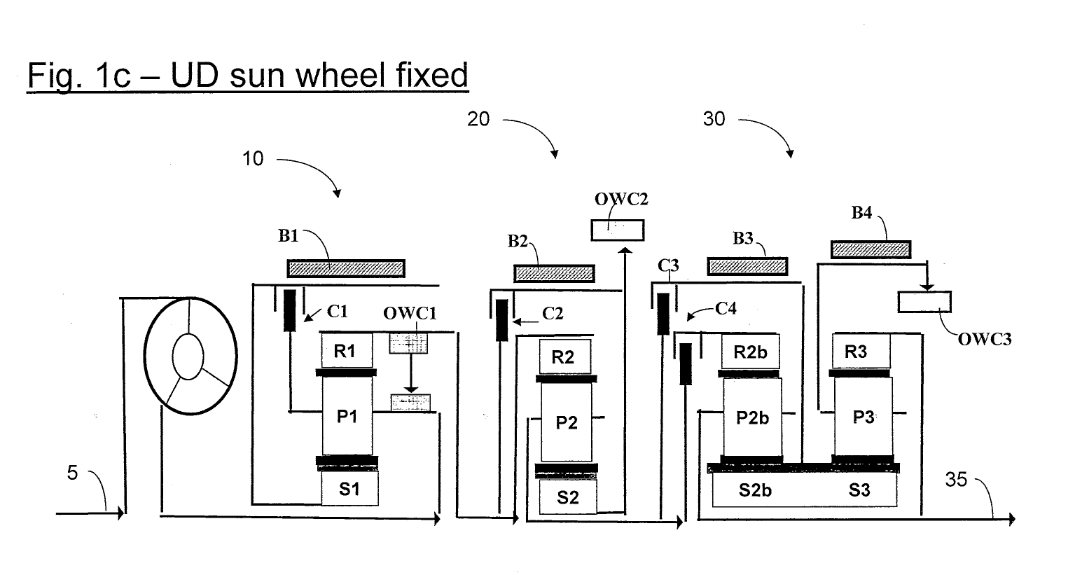

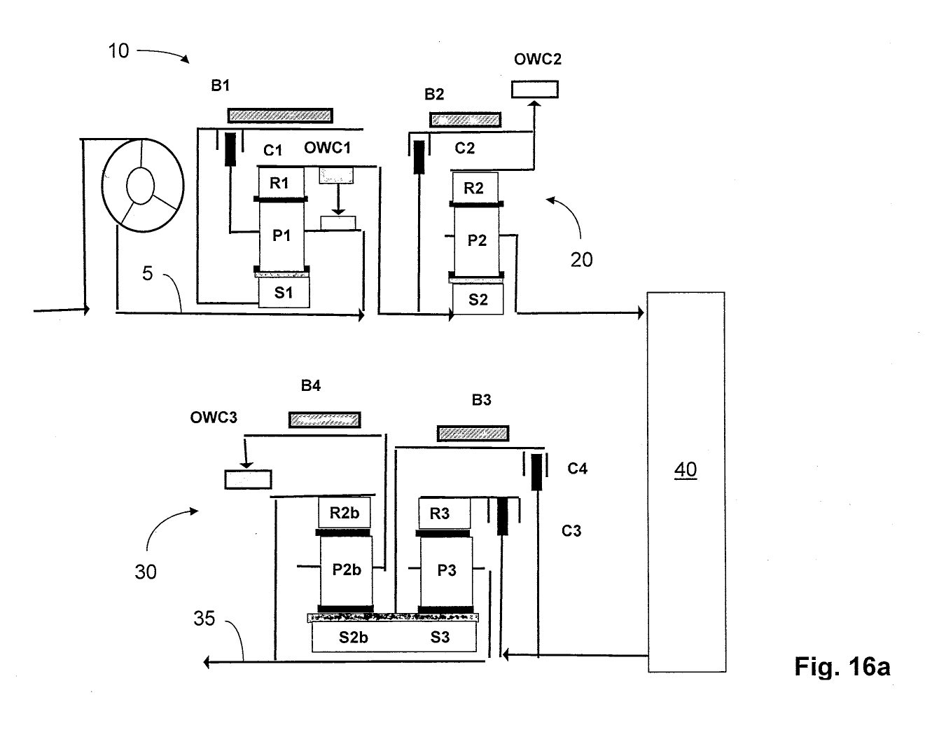

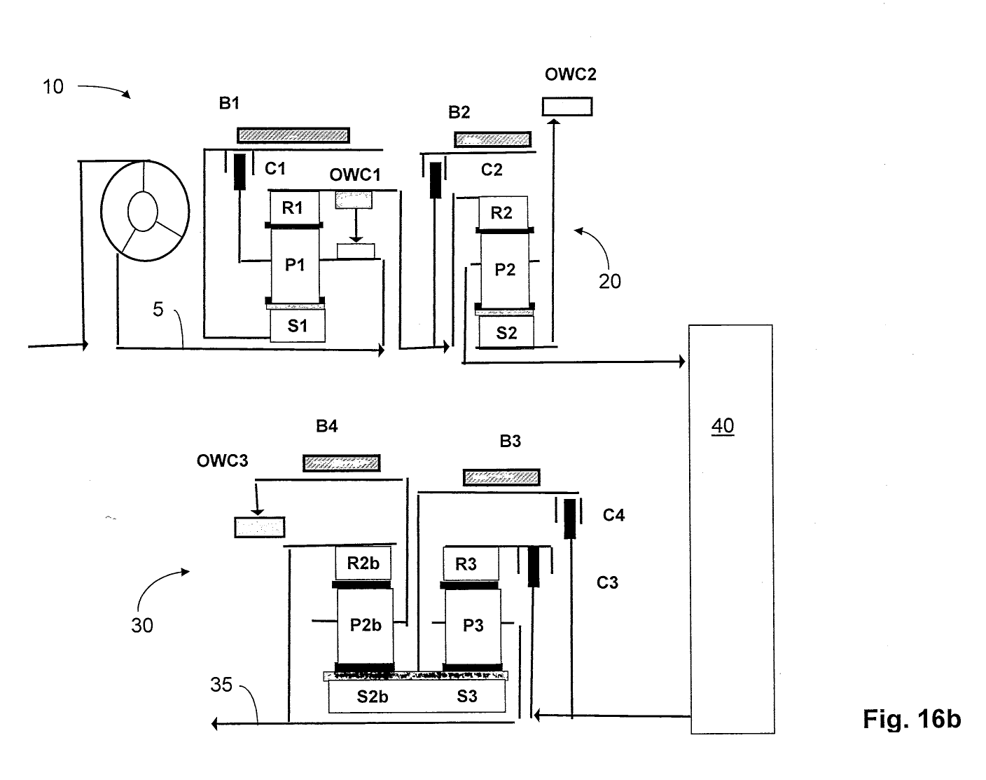

The invention is explained below by means of preferred embodiments with reference to the attached drawing. In the drawing, FIGS. 1-15 are each based on a north-south arrangement, and FIGS. 16-19 are based on an east-west arrangement.

In the drawing:

FIGS. 1a-c show schematic illustrations of the construction of a multispeed transmission according to the invention in a first embodiment, wherein an overdrive planetary gear is connected in series with an underdrive planetary gear and in series with a Simpson planetary gearset, more specifically in embodiments in which the sun wheel is fixed (FIG. 1c) or the annulus is fixed (FIG. 1b);

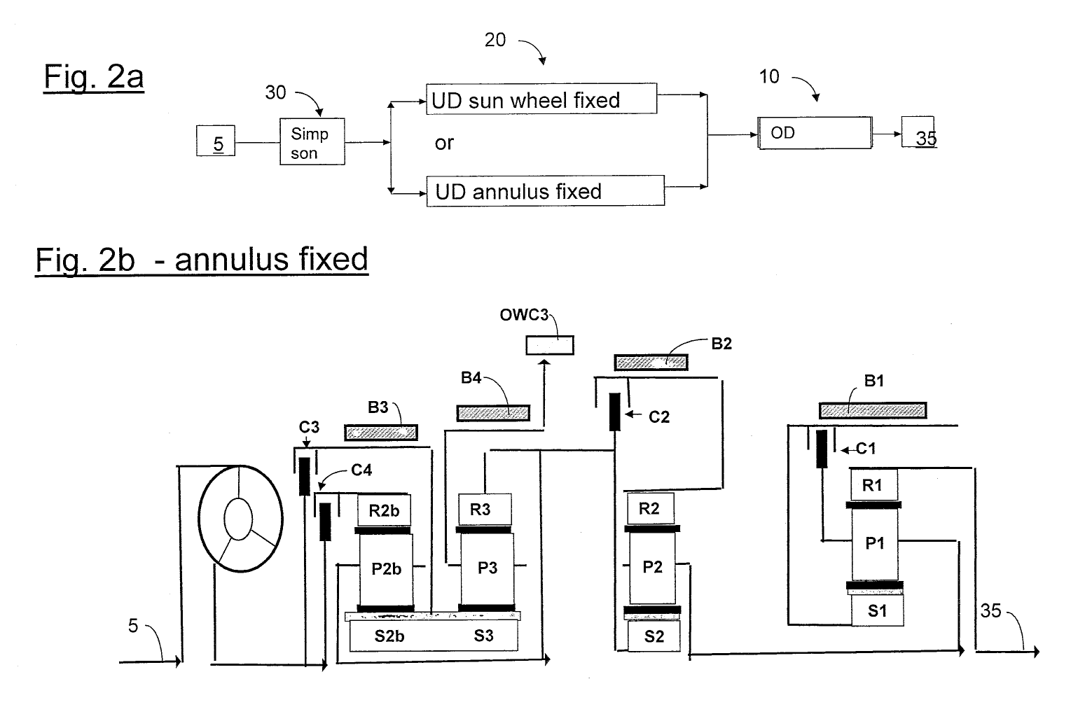

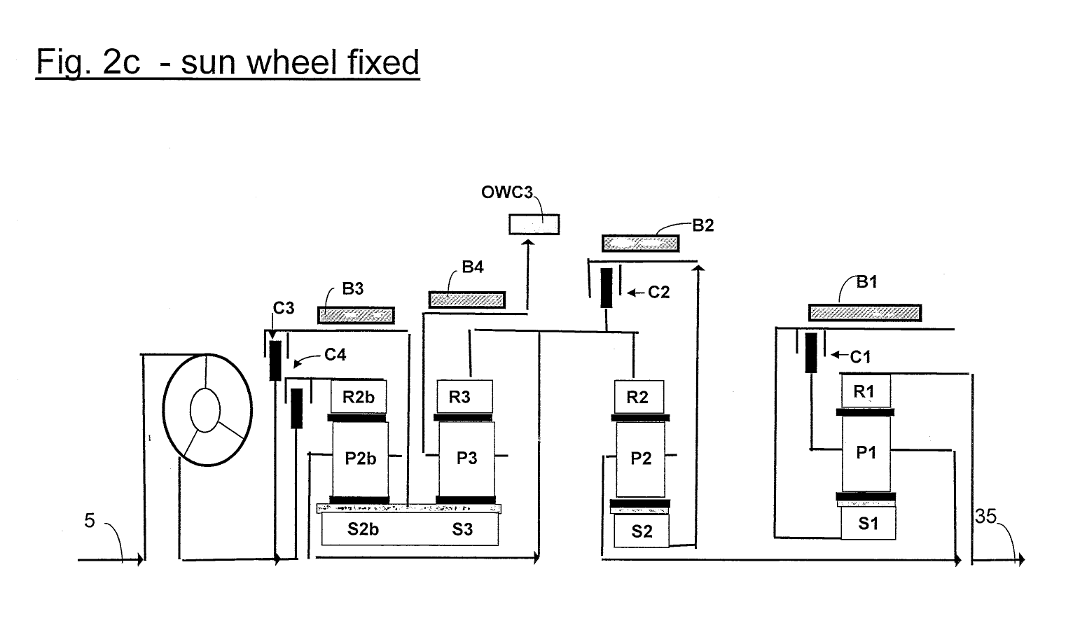

FIGS. 2a-c show a schematic illustration of the construction of a multispeed transmission according to the invention in a second embodiment, wherein a Simpson planetary gearset is connected in series with an underdrive planetary gear and in series with an overdrive planetary gear, more specifically in embodiments in which the sun wheel is fixed (FIG. 2c) or the annulus is fixed (FIG. 2b);

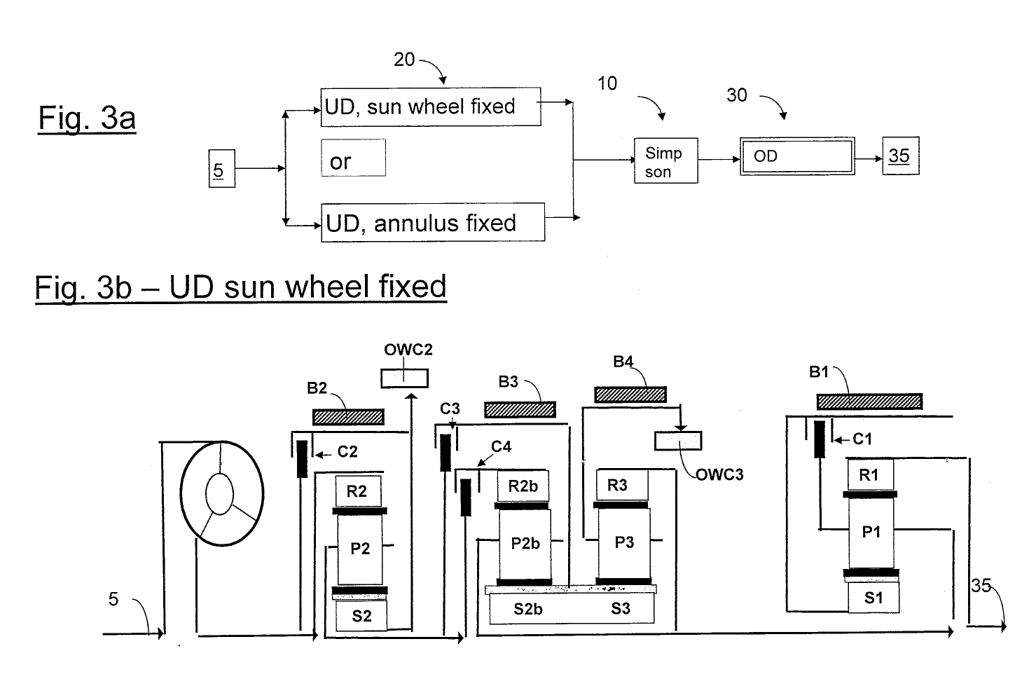

FIGS. 3a-c show a schematic illustration of the construction of a multispeed transmission according to the invention in a third embodiment, wherein an underdrive planetary gear (with a fixed sun wheel and optionally with a fixed annulus) is connected in series with a Simpson planetary gearset and in series with an overdrive planetary gear, more specifically in embodiments in which the sun wheel is fixed (FIG. 3b) or the annulus is fixed (FIG. 3c);

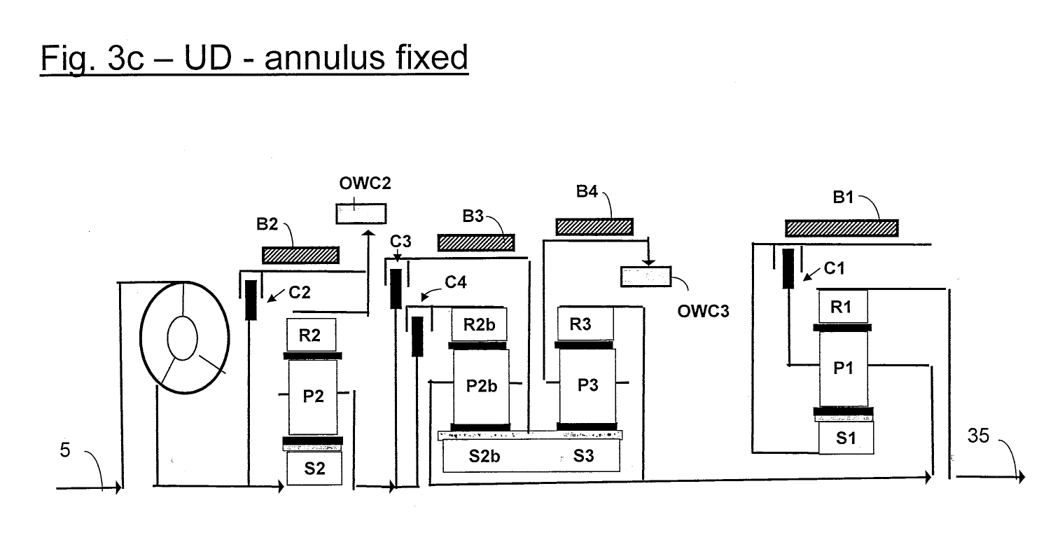

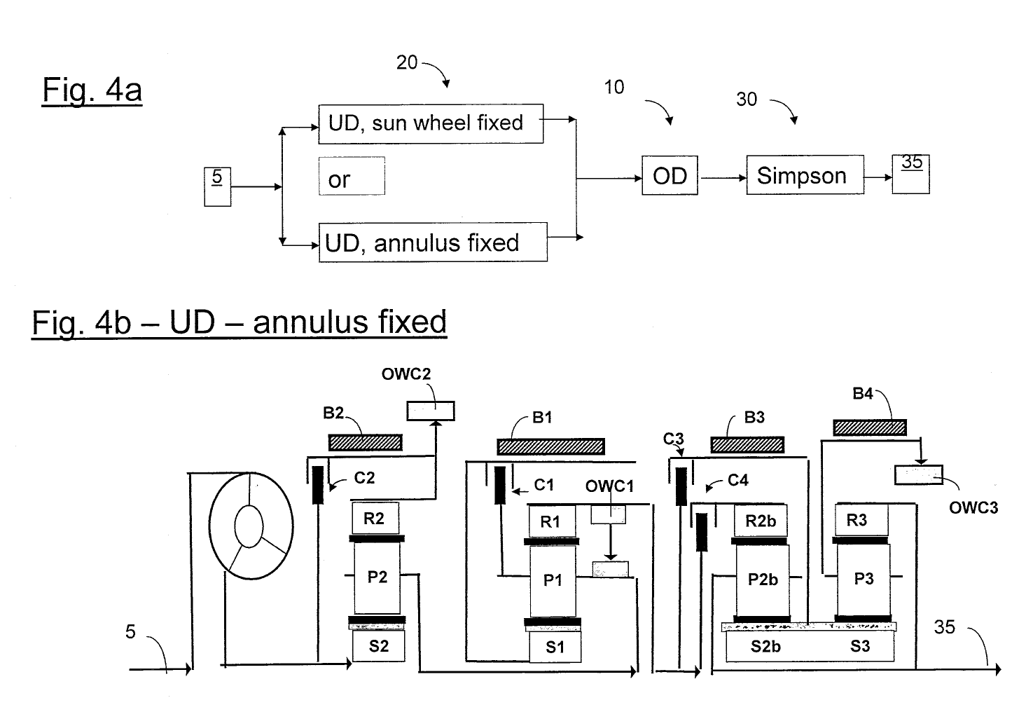

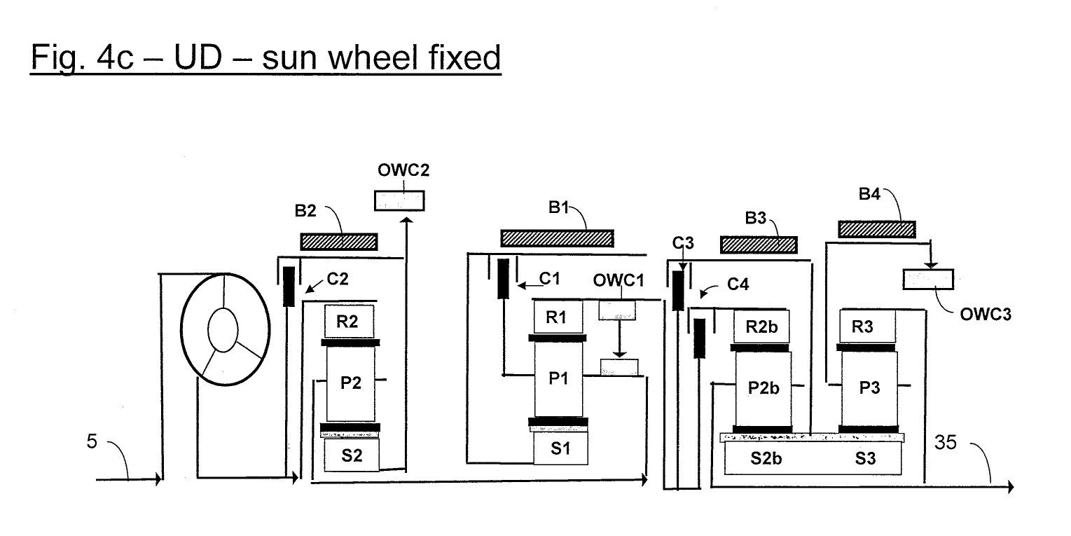

FIGS. 4a-c show a schematic illustration of the construction of a multispeed transmission according to the invention in a fourth embodiment, wherein an underdrive planetary gear is connected in series with an overdrive planetary gear and in series with a Simpson planetary gearset, more specifically in embodiments in which the sun wheel is fixed (FIG. 4c) or the annulus is fixed (FIG. 4b);

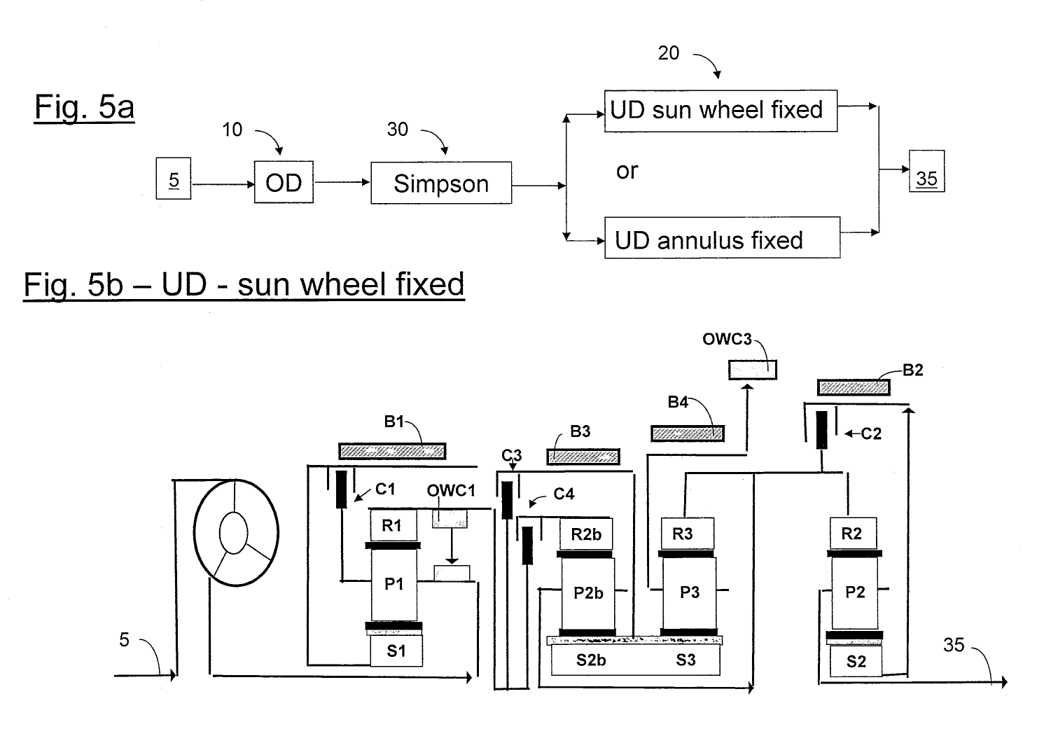

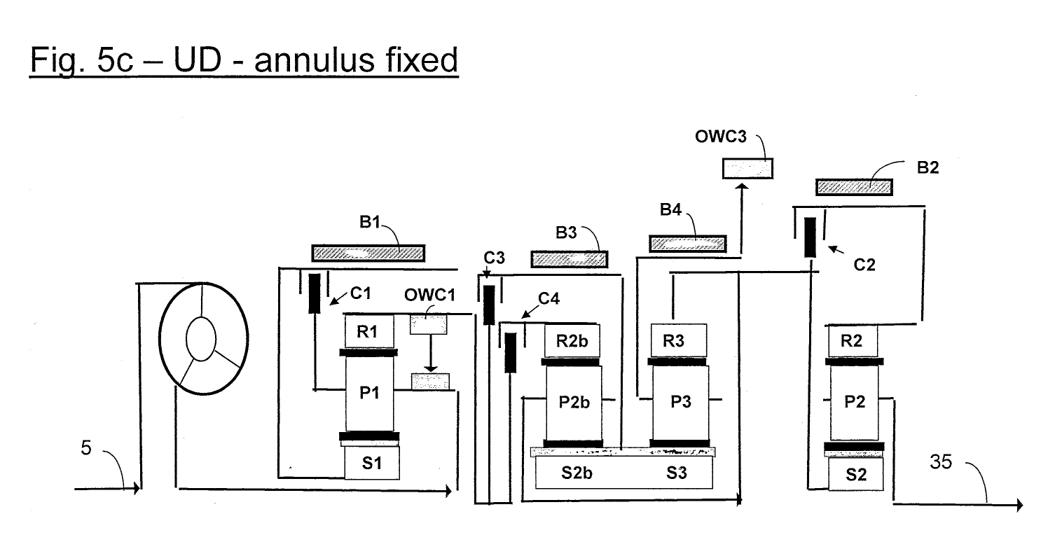

FIGS. 5a-c show a schematic illustration of the construction of a multispeed transmission according to the invention in a fifth embodiment, wherein an overdrive planetary gear is connected in series with a Simpson planetary gearset and in series with an underdrive planetary gear, more specifically in embodiments in which the sun wheel is fixed (FIG. 5b) or the annulus is fixed (FIG. 5c);

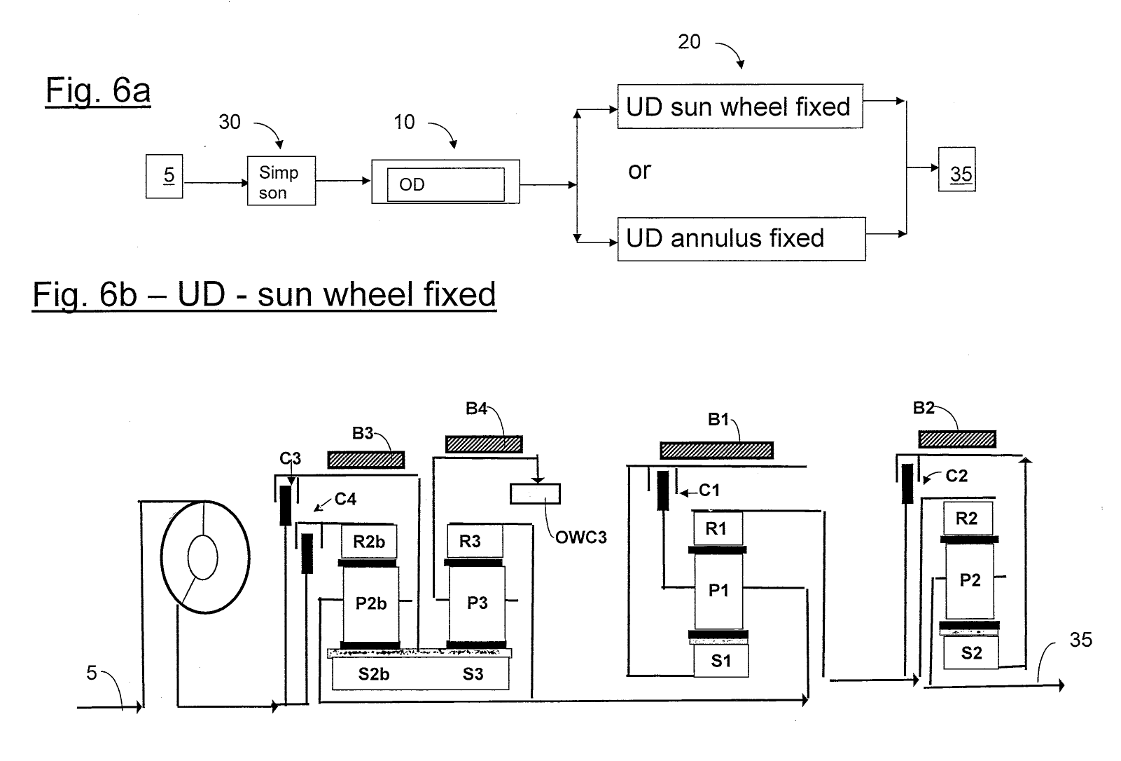

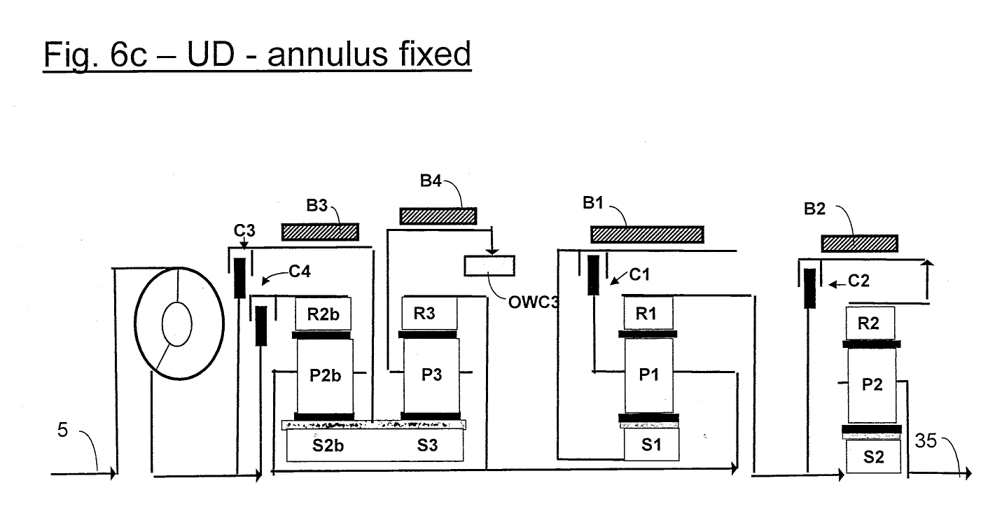

FIGS. 6a-c show a schematic illustration of the construction of a multispeed transmission according to the invention in a sixth embodiment, wherein a Simpson planetary gearset is connected in series with an overdrive planetary gear and in series with an underdrive planetary gear, more specifically in embodiments in which the sun wheel is fixed (FIG. 6b) or the annulus is fixed (FIG. 6c);

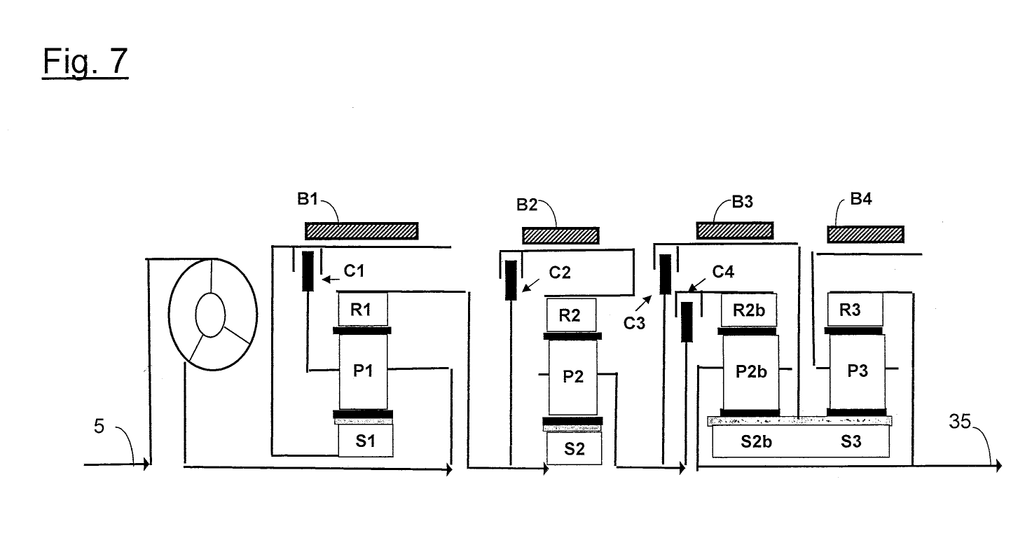

FIG. 7 shows a schematic illustration of the construction of a multispeed transmission according to the invention in another embodiment as an example of a possible embodiment without one-way clutches;

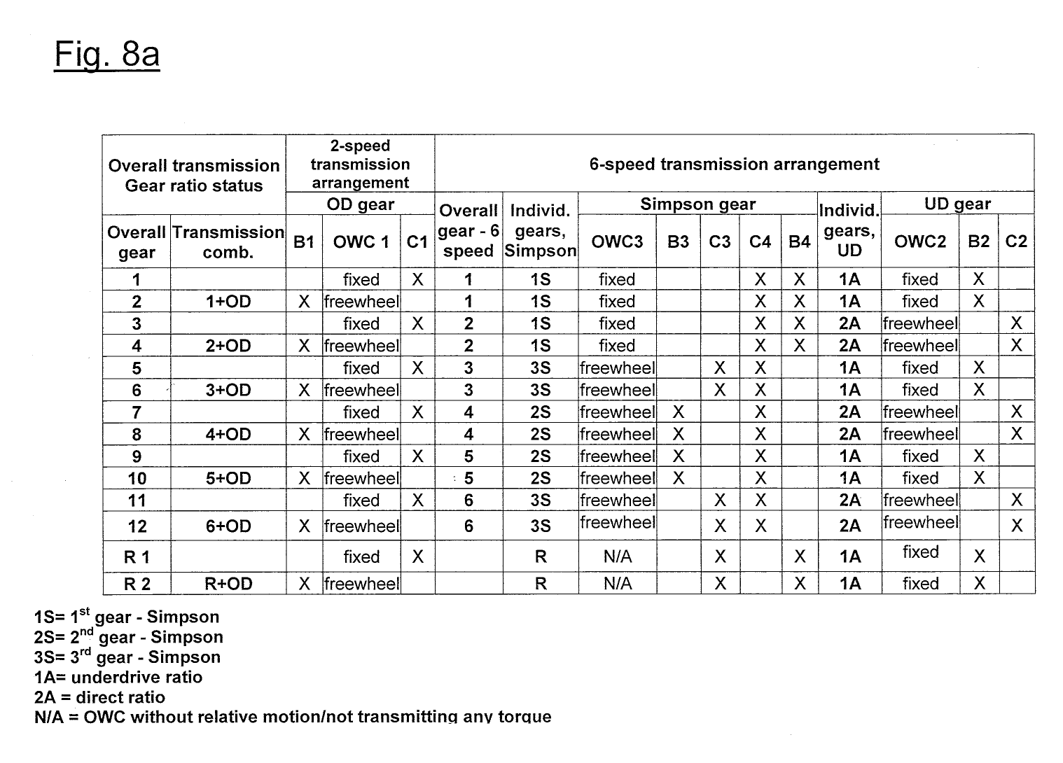

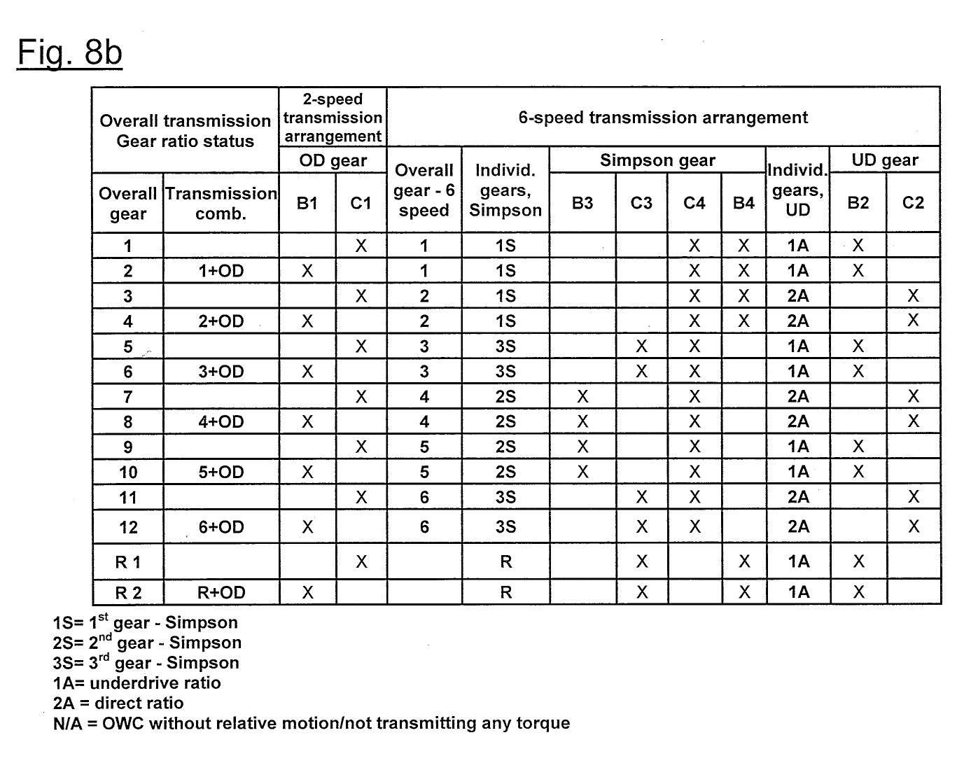

FIGS. 8a-b show truth tables for the multispeed transmission with (FIG. 8a) and without one-way clutches (truth table—FIG. 8b, transmission diagram—FIG. 7), from which it can be seen which of the torque transmission devices (brake bands, clutches or one-way clutches) are engaged or disengaged for a particular speed to be selected from the total of 12 theoretically selectable speeds; these truth tables can be applied to the embodiments in FIGS. 1a-c and FIGS. 4a-c;

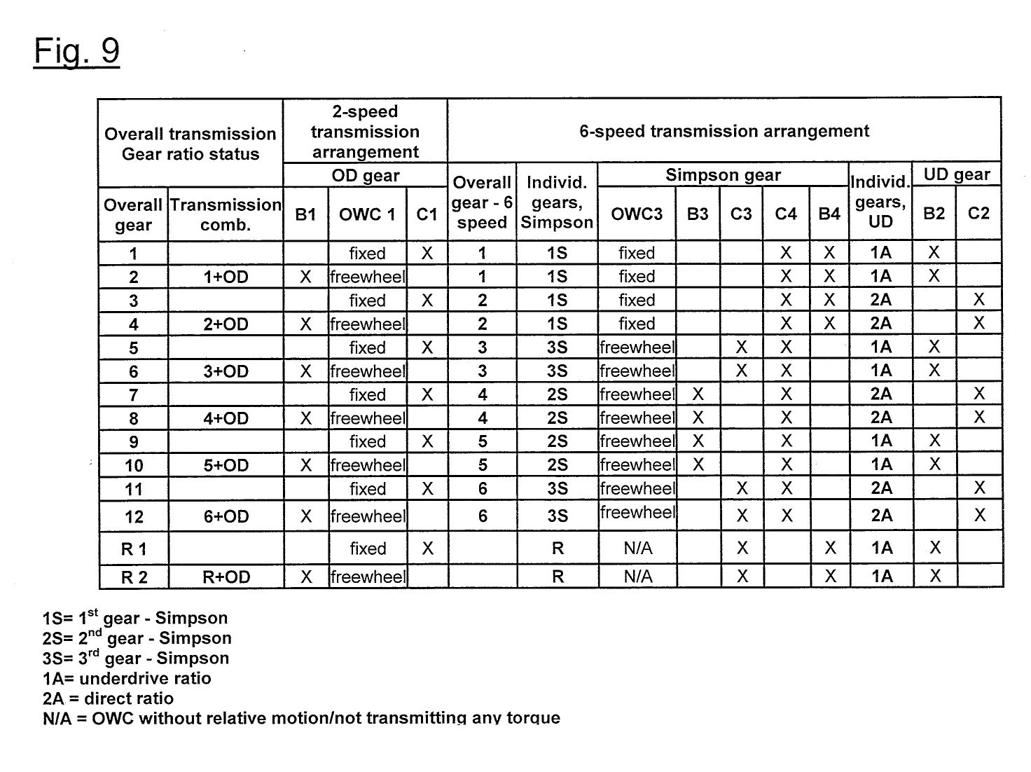

FIG. 9 shows a truth table which can be applied to a multispeed transmission according to the embodiments in FIGS. 5a-c;

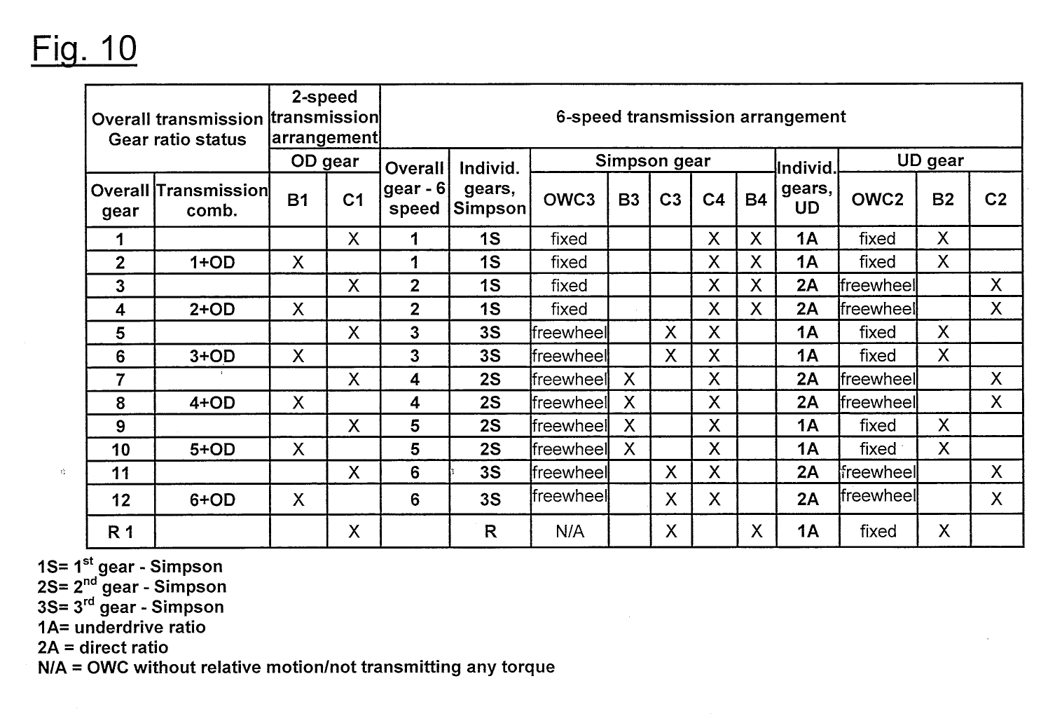

FIG. 10 shows a truth table which can be applied to a multispeed transmission according to the embodiments in FIGS. 3a-c;

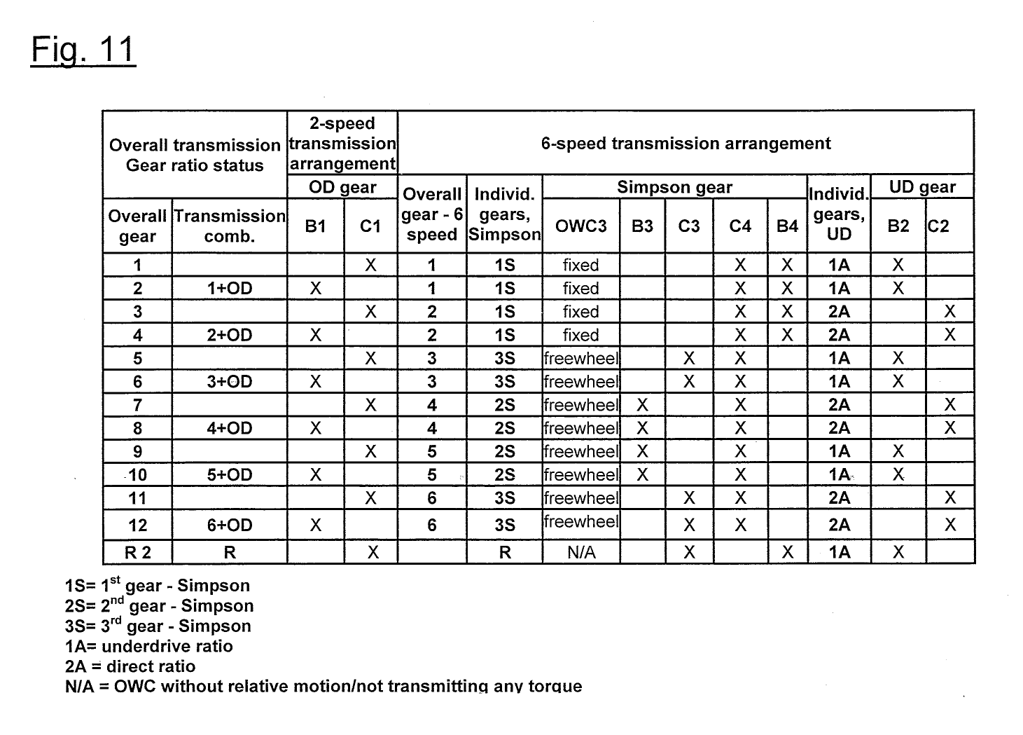

FIG. 11 shows a truth table which can be applied to a multispeed transmission according to the embodiments in FIGS. 2a-c and FIGS. 6a-c;

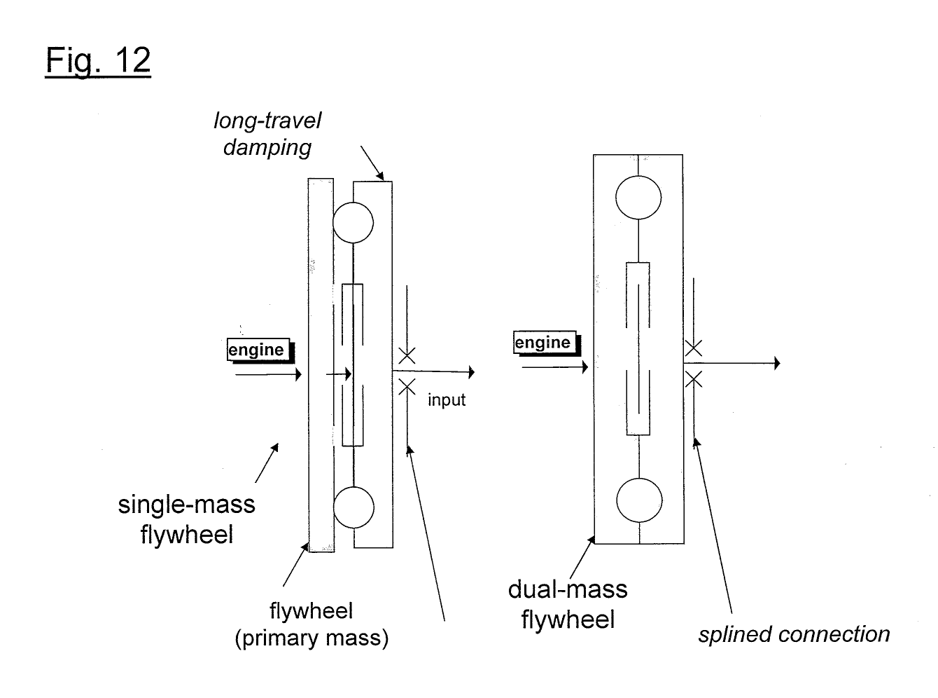

FIG. 12 shows starting systems with a single-mass and a dual-mass flywheel system;

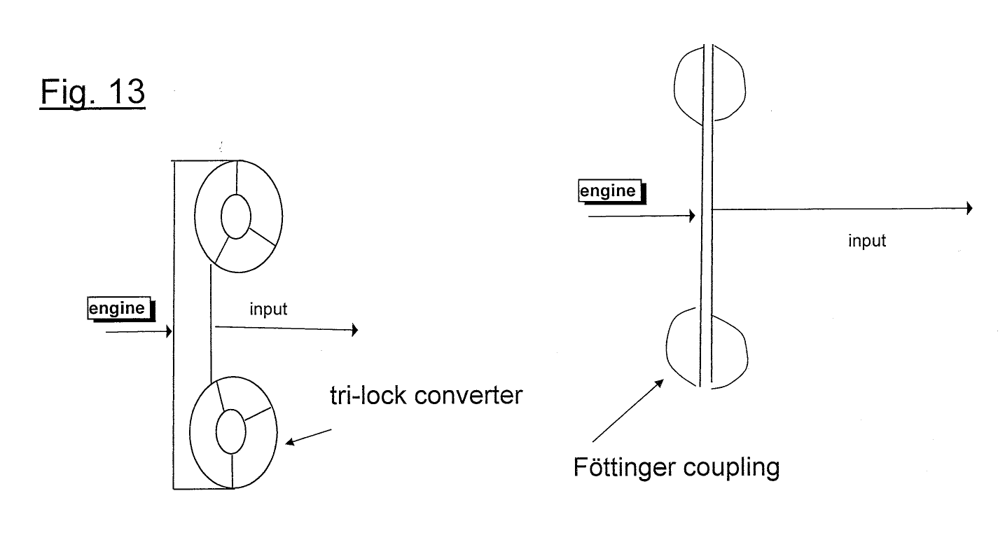

FIG. 13 shows starting systems with a tri-lock converter and a Föttinger coupling;

FIG. 14 shows schematic illustrations of conventional overdrive planetary gears in series with a 5R55E Simpson planetary gearset;

FIG. 15 shows a truth table for an 8-speed multispeed transmission, which is embodied as an example with gear ratio steps and gear ratio spreads; and

FIGS. 16-19 show schematic illustrations of further embodiments of a multi-speed transmission according to the invention having at least two transmission axes.

FIGS. 1a-c show a multispeed transmission according to the invention. On the input side, the multispeed transmission has an input element 5 connected in the drive train to the engine and, on the output side, has an output element 35 connected in the drive train to the final drive.

The multispeed transmission shown in FIGS. 1a-c furthermore has a Simpson planetary gearset 30, which has a common sun wheel S2b, S3, two annuluses R2b, R3 and two planet carrier arrangements P2b, P3.

The multispeed transmission furthermore comprises an overdrive planetary gear 10, which has a sun wheel S1, a planet carrier arrangement P1 and an annulus R1. The overdrive planetary gear 10 is connected in series with the Simpson planetary gearset 30 and is arranged ahead of the Simpson planetary gearset 30 on the transmission path from the input element 5 to the output element 35.

The multispeed transmission furthermore comprises an underdrive planetary gear 20, which has a sun wheel S2, a planet carrier arrangement P2 and an annulus R2 and is connected in series with the Simpson planetary gearset 30 and the overdrive planetary gear 10.

Moreover, the multispeed transmission shown in FIG. 1 has torque transmission devices, which, in the illustrative embodiment shown, comprise four brake bands B1-B4, four clutches C1-C4 and three one-way clutches OWC1-OWC3. Of these, torque transmission devices C1, OWC1 and B1 are assigned to the overdrive planetary gear 10, torque transmission devices C2, B2 and OWC2 are assigned to the underdrive planetary gear 20, and torque transmission devices C3, C4, B3, B4 and OWC3 are assigned to the Simpson planetary gearset 30.

More specifically, in FIG. 1b planet carrier arrangement P1 is rigidly connected to the input element 5 and can be selectively coupled to sun wheel S1 by means of a first clutch C1. Annulus RI is rigidly connected to sun wheel S2 and can be coupled selectively to annulus R2 by means of a second clutch C2. Planet carrier arrangement P2 can be coupled selectively to the common sun wheel S2b, S3 by means of a third clutch C3 and can be coupled selectively to annulus R2b by means of a fourth clutch C4. Planet carrier arrangement P2b is rigidly connected to the output element 35 and to annulus R3. Sun wheel S1, annulus R2, the common sun wheel S2b, S3 and planet carrier arrangement P3 can be braked by means of first, second, third and fourth brake bands B1, B2, B3, B4, respectively. Annulus R1 is coupled to planet carrier arrangement P1 by means of a first one-way clutch OWC1. Annulus R2 or sun wheel S2 is coupled to a second one-way clutch OWC2. Planet carrier arrangement P3 is coupled to a third one-way clutch OWC3.

Sun wheel S2 or annulus R2 can optionally be fixed in the underdrive planetary gear 20.

FIG. 1b shows the configuration with annulus R2 fixed. This configuration allows transmission ratios of the underdrive planetary gear 20 of less than 2, and allows transmission ratios and an overall spread of the overall multispeed transmission of up to 8.5.

FIG. 1c shows the analogous configuration with sun wheel S2 fixed. This configuration allows transmission ratios of the underdrive planetary gear 20 of more than 2, and allows transmission ratios and an overall spread of the overall multispeed transmission of up to 10.0.

FIGS. 2a-c to 6a-c show different configurations of the multispeed transmission according to the invention, which differ from one another as regards the sequence of Simpson planetary gearset 30, overdrive planetary gear 10 and underdrive planetary gear 20.

Common to the embodiments in FIGS. 1a-c and FIGS. 4a-c is the fact that the overdrive planetary gear 10 and the underdrive planetary gear 20 are arranged ahead of the Simpson planetary gearset 30, based on the transmission path running from the input element 5 to the output element 35.

Common to the embodiments in FIGS. 3a-c and 5a-c is the fact that the Simpson planetary gearset 30 is arranged between the overdrive planetary gear 10 and the underdrive planetary gear 20, based on the transmission path running from the input element 5 to the output element 35. In each of the embodiments in FIGS. 3a-c, the Simpson planetary gearset 30 is also arranged after the underdrive planetary gear 20, based on the transmission path running from the input element 5 to the output element 35, while, according to FIGS. 3a-c, the overdrive planetary gear 10 is arranged after the underdrive planetary gear 20 in the transmission path and, according to FIGS. 5a-c, the overdrive planetary gear 10 is arranged ahead of the underdrive planetary gear 20.

The configuration shown in FIGS. 2b, c will be described in greater detail below.

According to FIGS. 2b, c, annulus R1 is rigidly connected to the output element 35. Planet carrier arrangement P1 can be coupled selectively to sun wheel S1 by means of a first clutch C1 and is rigidly connected to planet carrier arrangement P2. Sun wheel S2 is rigidly connected to annulus R3 and to planet carrier arrangement P2b and can be coupled selectively to annulus R2 by means of a second clutch C2. Planet arrangement P2 is rigidly connected to planet arrangement P1. The input element 5 can be coupled selectively to the common sun wheel S2b, S3 by means of a third clutch C3 and to annulus R2b by means of a fourth clutch C4. Sun wheel S1, annulus R2 or sun wheel S2, the common sun wheel S2b, S3 and planet carrier arrangement P3 can be braked by means of first, second, third and fourth brake bands (or optionally by means of clutch systems) B1, B2, B3, B4, respectively. Planet carrier arrangement P3 is coupled to a one-way clutch OWC3.

In another embodiment (FIG. 2c), sun wheel S2 can be coupled to annulus R3 and planet carrier arrangement P2b by means of a clutch C2.

The configuration shown in FIGS. 3b, c will be described in greater detail below. According to FIGS. 3b, c, annulus R1 is rigidly connected to the output element 35. Planet carrier arrangement P1 can be coupled selectively to sun wheel S1 by means of a first clutch C1 and is rigidly connected to planet carrier arrangement P2b and to annulus R3. Annulus R2 is rigidly connected to the input element 5 and can be coupled selectively to sun wheel S2 by means of a second clutch C2. The common sun wheel S2b, S3 can be coupled selectively to planet carrier arrangement P2 by means of a third clutch C3. Annulus R2b can be coupled selectively to planet carrier arrangement P2 by means of a fourth clutch C4. Sun wheel S1, annulus R2 or sun wheel S2, the common sun wheel S2b, S3 and planet carrier arrangement P3 can be braked by means of first, second, third and fourth brake bands (or optionally by means of clutch systems) B1, B2, B3, B4, respectively. Annulus R2 or sun wheel S2 is coupled to a one-way clutch OWC2, and planet carrier arrangement P3 is coupled to a one-way clutch OWC3.

In another embodiment (FIG. 3c), sun wheel S2 is rigidly connected to the input element 5 and can be coupled selectively to annulus R2 by means of a second clutch C2.

The configuration shown in FIGS. 4b, c will be described in greater detail below. According to FIGS. 4b, c, planet carrier arrangement P1 can be connected selectively to sun wheel S1 by means of a first clutch C1 and is rigidly connected to planet carrier arrangement P2. Sun wheel S2 is rigidly connected to the input element 5 and can be coupled selectively to annulus R2 by means of a second clutch C2. Annulus R1 can be coupled selectively to the common sun wheel S2b, S3 by means of a third clutch C3 and can be coupled selectively to annulus R2b by means of a fourth clutch C4. Planet carrier arrangement P2b is rigidly connected to annulus R3 and to the output element 35. Sun wheel S1, annulus R2 or sun wheel S2, the common sun wheel S2b, S3 and planet carrier arrangement P3 can be braked by means of first, second, third and fourth brake bands (or optionally by means of clutch systems) B1, B2, B3, B4, respectively. Annulus R1 is coupled to planet carrier arrangement P1 by means of a one-way clutch OWC1. Annulus R2 or sun wheel S2 is coupled to a second one-way clutch OWC2. Planet carrier arrangement P3 is coupled to a third one-way clutch OWC3.

In another embodiment (FIG. 4c), annulus R2 is rigidly connected to the input element 5 and can be coupled selectively to sun wheel S2 by means of a second clutch C2.

The configuration shown in FIGS. 5b, c will be described in greater detail below.

According to FIGS. 5b, c, planet carrier arrangement P1 can be coupled selectively to sun wheel S1 by means of a first clutch C1 and is rigidly connected to the input element 5. Sun wheel S2 can be coupled selectively to annulus R3 and to annulus R3 by means of a second clutch C2. Annulus R1 can be coupled selectively to the common sun wheel S2b, S3 by means of a third clutch C3 and to annulus R2b by means of a fourth clutch C4. Planet carrier arrangement P2b is rigidly connected to annulus R2 and to annulus R3, and planet carrier arrangement P2 is rigidly connected to the output element 35. Sun wheel S1, annulus R2 or sun wheel S2, the common sun wheel S2b, S3 and planet carrier arrangement P3 can be braked by means of first, second, third and fourth brake bands B1, B2, B3, B4, respectively (or optionally by means of clutch systems). Annulus R1 is coupled to planet carrier arrangement P1 by means of a first one-way clutch OWC1 and planet carrier arrangement P3 is coupled to a one-way clutch OWC3.

In another embodiment, sun wheel S2 can be coupled selectively to annulus R3 by means of a second clutch C2.

The configuration shown in FIGS. 6b, c will be described in greater detail below. According to FIGS. 6b, c, planet carrier arrangement P1 can be coupled selectively to sun wheel S1 by means of a first clutch C1 and is rigidly connected to planet carrier arrangement P2b and to annulus R3. Annulus R1 can be coupled selectively to sun wheel S2 by means of a second clutch C2 and is rigidly connected to annulus R2. Planet carrier arrangement P2 is rigidly connected to the output element 35. The input element 5 can be coupled selectively to the common sun wheel S2b, S3 by means of a third clutch C3 and to annulus R2b by means of a fourth clutch C4. Sun wheel S1, annulus R2 or sun wheel S2, the common sun wheel S2b, S3 and planet carrier arrangement P3 can be braked by means of first, second, third and fourth brake bands B1, B2, B3, B4, respectively (or optionally by means of clutch systems). Planet carrier arrangement P3 is coupled to a one-way clutch OWC3.

In another embodiment, annulus R1 can be coupled selectively to annulus R2 by means of a second clutch C2 and is rigidly connected to the sun wheel.

All the embodiments in FIGS. 1-6 can be combined with all starting systems, this depending on the overall spread achieved. As shown in FIG. 13, these starting systems can be a torque converter in combination with a relatively small or medium transmission spread or a Föttinger coupling with a large transmission spread.

In another possible use, it is possible to dispense with a torque converter, even in applications involving a large transmission spread, and optionally, as shown in FIG. 12, to use a single-mass or dual-mass flywheel. In this case, either clutch C1 or clutch C2 can be used as starting clutches in those applications which do not involve one-way clutches. Clutch C4 can be used as a starting clutch in all the transmission embodiments, without exception.

FIGS. 8a-b show truth tables for the multispeed transmission with (cf. FIGS. 1a-c and FIGS. 4a-c) and without (FIG. 7) one-way clutches, from which it can be seen which of the torque transmission devices (i.e. which of the four brake bands B1-B4, of the four clutches C1-C4 and of the three one-way clutches OWC1-OWC3) are engaged or disengaged for a particular speed which is to be engaged from among the total of 12 that can theoretically be selected; the truth tables in FIGS. 8a-b can be applied to the embodiments in FIGS. 1a-c and FIGS. 4a-c.

FIG. 8b corresponds to a configuration in which the three one-way clutches OWC1-OWC3 are eliminated and clutches C1 and C2 are ‘drive’ clutches. This configuration is shown in FIG. 7 and can be applied to all versions shown in FIGS. 1-6.

These value tables show the Simpson planetary gearset 30 and the associated clutches in a block, enabling a total of three speeds to be selected (1S-3S with application of B3, C3, C4 and B4). In the Simpson planetary gearset 30, reverse gear is furthermore achieved by the application of brake band B4 and clutch C3. Another block shows the underdrive planetary gear 20 with a total of 2 gear ratio steps 1A and 2A. In another block, the overdrive planetary gear 10 with two gear ratio steps+OD or—OD with the application of B1 is shown. In total, 12 gear ratio steps including 2 reverse gears are achieved through variation of the individual gear ratio steps of the overdrive planetary gear 10, of the underdrive planetary gear 20 and of the Simpson planetary gearset 30.

FIG. 9 shows a truth table which can be applied to a multispeed transmission in accordance with the embodiments in FIGS. 5a-c. Here, the underdrive planetary gear 20 is always connected behind the Simpson planetary set 30 and requires a direct gear ratio in the underdrive planetary gear 20 in both reverse gears.

FIG. 10 shows a truth table which can be applied to a multispeed transmission in accordance with the embodiments in FIGS. 3a-c. Here, the overdrive planetary gear 10 is always connected behind the Simpson planetary set and requires a direct gear ratio in the overdrive planetary gear 10 and hence only one reverse gear, which is achieved by means of the Simpson planetary set in series with the underdrive planetary gear 20.

FIG. 11 shows a truth table which can be applied to a multispeed transmission in accordance with the embodiments in FIGS. 2a-c and FIGS. 6a-c. Here, the overdrive planetary gear 10 and the underdrive planetary gear 20 are always connected behind the Simpson planetary set 30 and require a direct gear ratio in the overdrive and underdrive planetary gears in reverse gear, and hence only one reverse gear is achieved, which is achieved by means of the Simpson planetary gear 30.

FIGS. 16a-b show schematically the construction of a multispeed transmission according to the invention in another embodiment. This has two transmission axes, wherein an overdrive planetary gear 10 is connected in series with an underdrive planetary gear 20 on one of said transmission axes, wherein this arrangement is connected in series with a Simpson planetary gearset 30 on a second transmission axis via a transfer gear 40 (FIG. 16b showing an embodiment with a fixed sun wheel and FIG. 16a showing an embodiment with a fixed annulus).

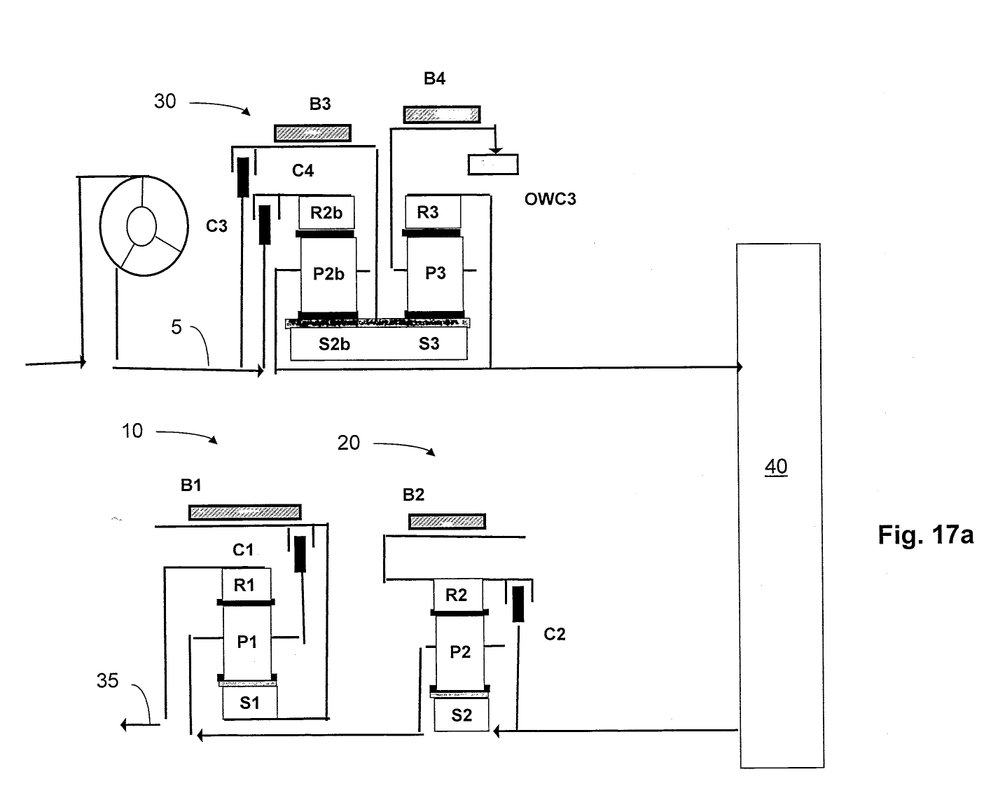

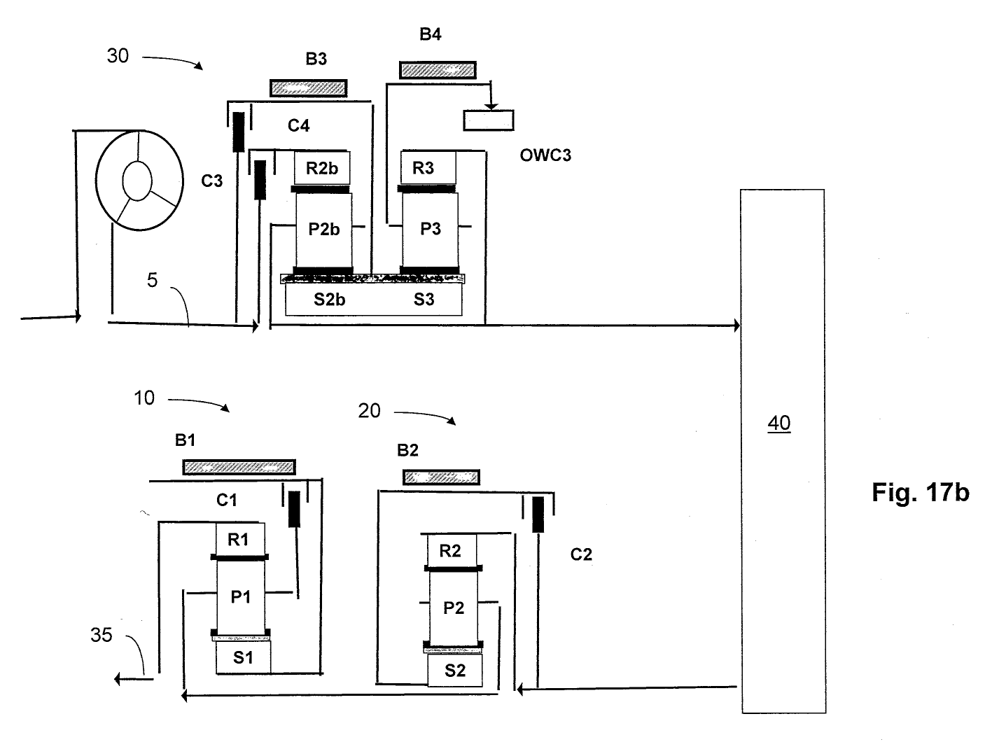

FIGS. 17a-b show schematically the construction of a multispeed transmission according to the invention in another embodiment. This likewise has two transmission axes, wherein a Simpson planetary gearset 30 is arranged on one of said transmission axes and is connected in series, via a transfer gear 40, with an arrangement situated on a second transmission axis and comprising an overdrive planetary gear 10 and an underdrive planetary gear 20 (FIG. 17b showing an embodiment with a fixed sun wheel and FIG. 17a showing an embodiment with a fixed annulus).

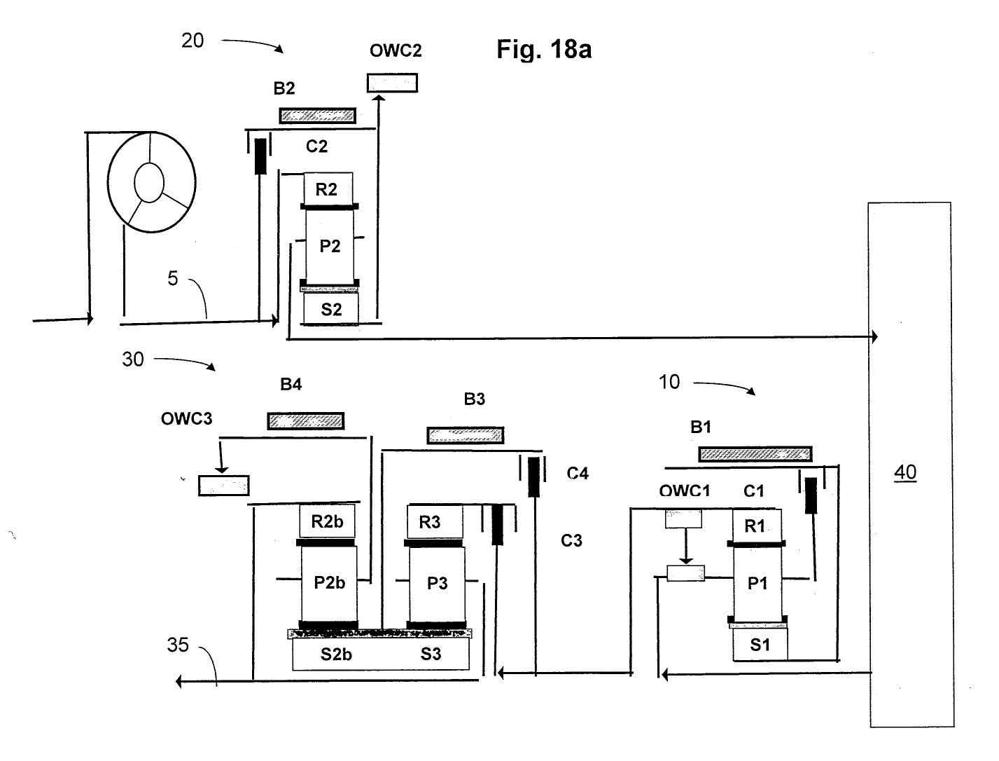

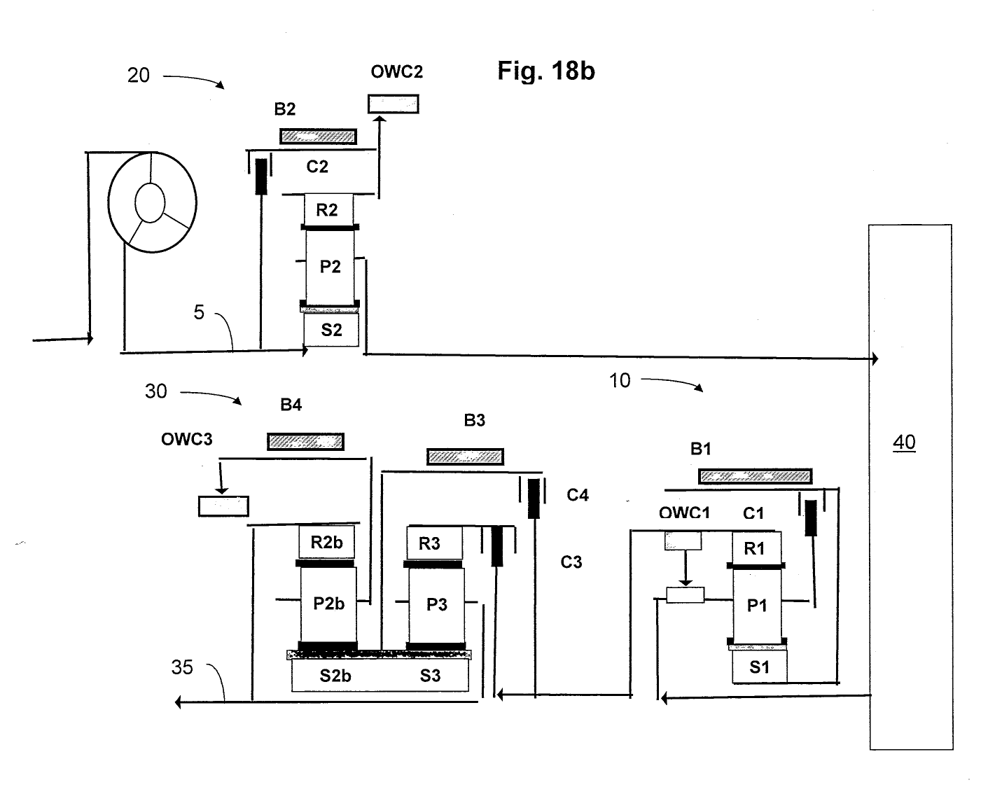

FIGS. 18a-b show schematically the construction of a multispeed transmission according to the invention in another embodiment. This likewise has two transmission axes, wherein an underdrive planetary gear 20 is arranged on one of said transmission axes and is connected in series, via a transfer gear 40, with an arrangement situated on a second transmission axis and comprising an overdrive planetary gear 10 and a Simpson planetary gearset 30 (FIG. 18a showing an embodiment with a fixed sun wheel and FIG. 18b showing an embodiment with a fixed annulus).

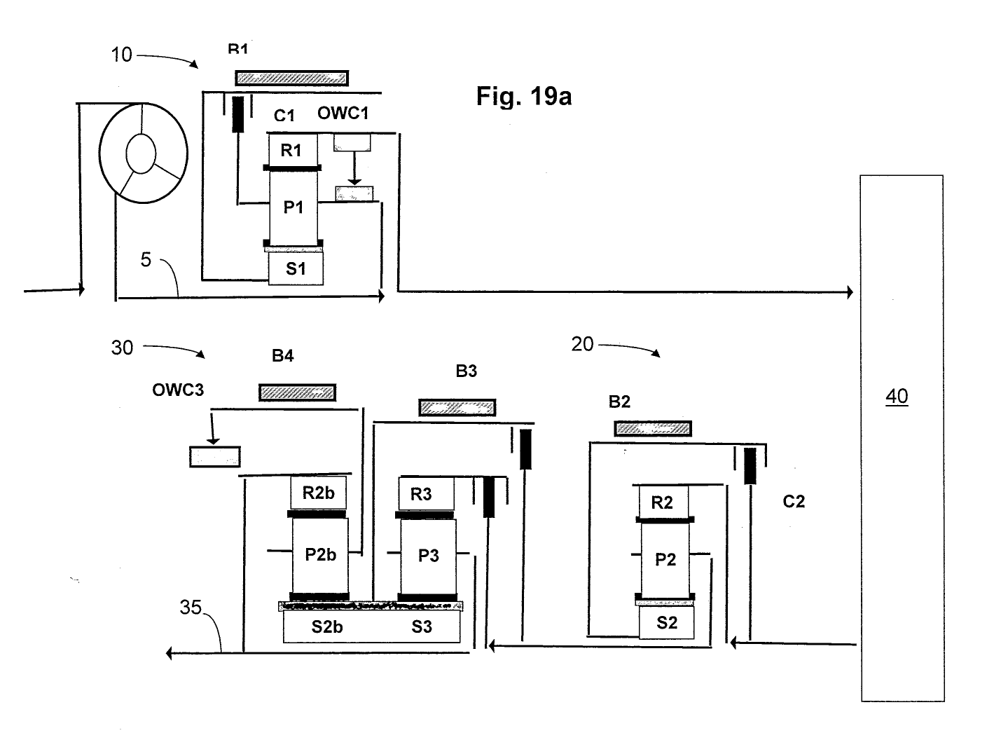

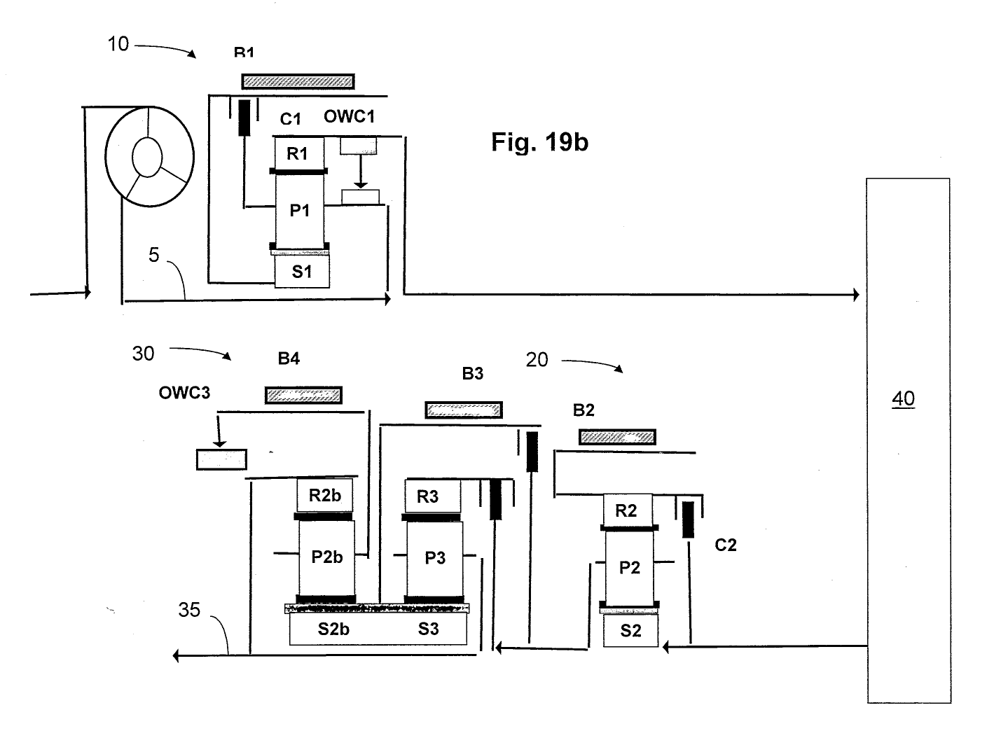

FIGS. 19a-b show schematically the construction of a multispeed transmission according to the invention in another embodiment. This likewise has two transmission axes, wherein an overdrive planetary gear 10 is arranged on one of said transmission axes and is connected in series, via a transfer gear 40, with an arrangement situated on a second transmission axis and comprising an underdrive planetary gear 20 and a Simpson planetary gearset 30 (FIG. 19a showing an embodiment with a fixed sun wheel and FIG. 19b showing an embodiment with a fixed annulus).

1. A multispeed transmission, having:
an input element;
an output element;
a Simpson planetary gearset having a common third sun wheel, a third annulus, a fourth annuluses and third and fourth planet carrier arrangements;
an overdrive planetary gear having a first sun wheel, a first planet carrier arrangement, and a first annulus, the overdrive planetary gear connected in series with the Simpson planetary gearset; and
an underdrive planetary gear having a second sun wheel, a second planet carrier arrangement, and a second annulus, the underdrive planetary gear connected in series with the Simpson planetary gearset and the overdrive planetary gear.

2. (canceled)

3. The multispeed transmission of claim 1 wherein
the overdrive planetary gear is arranged ahead of the Simpson planetary gearset, based on a transmission path running from the input element to the output element.

4. The multispeed transmission of claim 1
wherein
the Simpson planetary gearset is arranged after the underdrive planetary gear, based on a transmission path running from the input element to the output element.

5. The multispeed transmission of claim 1
wherein
the Simpson planetary gearset is arranged ahead of the underdrive planetary gear, based on a transmission path running from the input element to the output element.

6. The multispeed transmission of claim 1
wherein
the Simpson planetary gearset is arranged ahead of the overdrive planetary gear, based on a transmission path running from the input element to the output element.

7-26. (canceled)

27. The multispeed transmission of claim 1
wherein
the transmission is embodied without one-way clutches.

28. The multispeed transmission of claim 1
wherein,
the transmission is not equipped with a torque converter.

29. The multispeed transmission of claim 28, further comprising
a starting clutch.

30. The multispeed transmission
of claim 1, further comprising
a torque converter; and
a Föttinger coupling.

31. (canceled)

32. The multispeed transmission of claim 1
wherein,
one of the overdrive gear, the underdrive gear, and the Simpson planetary gear is positioned on a first axis; and;
another of the overdrive gear, the underdrive gear, and the Simpson planetary gear is positioned on a second axis offset from the first axis.

33. The multispeed transmission of claim 1 further comprising
a brake configured to selectively hold the second sun wheel against rotation.

34. The multispeed transmission of claim 33 further comprising
a one way clutch configured to constrain the second sun wheel to rotate only in one direction.

35. The multispeed transmission of claim 1 further comprising
a brake configured to selectively hold the second annulus against rotation.

36. The multispeed transmission of claim 35 further comprising
a one way clutch configured to constrain the second annulus to rotate only in one direction.

37. The multispeed transmission of claim 1, wherein
the first planet carrier arrangement is rigidly connected to the input element; and
the third planet carrier arrangement is rigidly connected to the output element and to the fourth annulus; and further comprising
a first brake configured to selectively hold the first sun wheel against rotation;
a third brake configured to selectively hold the common third sun wheel against rotation;
a fourth brake configured selectively to hold the fourth planet carrier arrangement against rotation;
a first clutch configured to selectively couple two of the first sun wheel, the first planet carrier arrangement, and the first annulus to one another;
a third clutch configured to selectively couple the second planet carrier arrangement to the common third sun wheel; and
a fourth clutch configured to selectively couple the second planet carrier arrangement to the third annulus.

38. The multispeed transmission of claim 37, wherein
the first annulus is rigidly connected to the second sun wheel; and further comprising
a second brake configured to selectively hold the second annulus against rotation; and
a second clutch configured to selectively couple two of the second sun wheel, the second planet carrier arrangement, and the second annulus to one another.

39. The multispeed transmission of claim 37, wherein
the first annulus is rigidly connected to the second annulus; and further comprising
a second brake configured to selectively hold the second sun wheel against rotation; and
a second clutch configured to selectively couple two of the second sun wheel, the second planet carrier arrangement, and the second annulus to one another.

40. The multispeed transmission of claim 1, wherein
the first planet carrier arrangement is rigidly connected to the second planet carrier arrangement;
the first annulus is rigidly connected to the output element; and
the third planet carrier arrangement is rigidly connected to the fourth annulus; and further comprising
a first brake configured to selectively hold the first sun wheel against rotation;
a third brake configured to selectively hold the common third sun wheel against rotation;
a fourth brake configured selectively to hold the fourth planet carrier arrangement against rotation;
a first clutch configured to selectively couple two of the first sun wheel, the first planet carrier arrangement, and the first annulus to one another;
a third clutch configured to selectively couple the input element to the common third sun wheel; and
a fourth clutch configured to selectively couple the input element to the third annulus.

41. The multispeed transmission of claim 40, wherein
the third planet carrier arrangement and the fourth annulus are rigidly connected to the second sun wheel; and further comprising
a second brake configured to selectively hold the second annulus against rotation; and
a second clutch configured to selectively couple two of the second sun wheel, the second planet carrier arrangement, and the second annulus to one another.

42. The multispeed transmission of claim 40, wherein
the third planet carrier arrangement and the fourth annulus are rigidly connected to the second annulus; and further comprising
a second brake configured to selectively hold the second sun wheel against rotation; and
a second clutch configured to selectively couple two of the second sun wheel, the second planet carrier arrangement, and the second annulus to one another.

43. The multispeed transmission of claim 1, wherein
the first annulus is rigidly connected to the output element; and
the third planet carrier arrangement is rigidly connected to the first planet carrier arrangement and to the fourth annulus; and further comprising
a first brake configured to selectively hold the first sun wheel against rotation;
a third brake configured to selectively hold the common third sun wheel against rotation;
a fourth brake configured selectively to hold the fourth planet carrier arrangement against rotation;
a first clutch configured to selectively couple two of the first sun wheel, the first planet carrier arrangement, and the first annulus to one another;
a third clutch configured to selectively couple the second planet carrier arrangement to the common third sun wheel; and
a fourth clutch configured to selectively couple the second planet carrier arrangement to the third annulus.

44. The multispeed transmission of claim 43, wherein
the input element is rigidly connected to the second sun wheel; and further comprising
a second brake configured to selectively hold the second annulus against rotation; and
a second clutch configured to selectively couple two of the second sun wheel, the second planet carrier arrangement, and the second annulus to one another.

45. The multispeed transmission of claim 43, wherein
the input element is rigidly connected to the second annulus; and further comprising
a second brake configured to selectively hold the second sun wheel against rotation; and
a second clutch configured to selectively couple two of the second sun wheel, the second planet carrier arrangement, and the second annulus to one another.

46. The multispeed transmission of claim 1, wherein
the first planet carrier arrangement is rigidly connected to the second planet carrier arrangement; and
the third planet carrier arrangement and the fourth annulus are rigidly connected to the output element; and further comprising
a first brake configured to selectively hold the first sun wheel against rotation;
a third brake configured to selectively hold the common third sun wheel against rotation;
a fourth brake configured selectively to hold the fourth planet carrier arrangement against rotation;
a first clutch configured to selectively couple two of the first sun wheel, the first planet carrier arrangement, and the first annulus to one another;
a third clutch configured to selectively couple the first annulus to the common third sun wheel; and
a fourth clutch configured to selectively couple the first annulus to the third annulus.

47. The multispeed transmission of claim 46, wherein
the input element is rigidly connected to the second sun wheel; and further comprising
a second brake configured to selectively hold the second annulus against rotation; and
a second clutch configured to selectively couple two of the second sun wheel, the second planet carrier arrangement, and the second annulus to one another.

48. The multispeed transmission of claim 46, wherein
the input element is rigidly connected to the second annulus; and further comprising
a second brake configured to selectively hold the second sun wheel against rotation; and
a second clutch configured to selectively couple two of the second sun wheel, the second planet carrier arrangement, and the second annulus to one another.

49. The multispeed transmission of claim 1, wherein
the first planet carrier arrangement is rigidly connected to the input element;
the second planet carrier arrangement is rigidly connected to the output element; and
the third planet carrier arrangement is rigidly connected to the fourth annulus; and further comprising
a first brake configured to selectively hold the first sun wheel against rotation;
a third brake configured to selectively hold the common third sun wheel against rotation;
a fourth brake configured selectively to hold the fourth planet carrier arrangement against rotation;
a first clutch configured to selectively couple two of the first sun wheel, the first planet carrier arrangement, and the first annulus to one another;
a third clutch configured to selectively couple the first annulus to the common third sun wheel; and
a fourth clutch configured to selectively couple the first annulus to the third annulus.

50. The multispeed transmission of claim 49, wherein
the third planet carrier arrangement and fourth annulus are rigidly connected to the second sun wheel; and further comprising
a second brake configured to selectively hold the second annulus against rotation; and
a second clutch configured to selectively couple two of the second sun wheel, the second planet carrier arrangement, and the second annulus to one another.

51. The multispeed transmission of claim 49, wherein
the third planet carrier arrangement and fourth annulus are rigidly connected to the second annulus; and further comprising
a second brake configured to selectively hold the second sun wheel against rotation; and
a second clutch configured to selectively couple two of the second sun wheel, the second planet carrier arrangement, and the second annulus to one another.

52. The multispeed transmission of claim 1, wherein
the second planet carrier arrangement is rigidly connected to the output element; and
the third planet carrier arrangement and the fourth annulus are rigidly connected to the first planet carrier arrangement; and further comprising
a first brake configured to selectively hold the first sun wheel against rotation;
a third brake configured to selectively hold the common third sun wheel against rotation;
a fourth brake configured selectively to hold the fourth planet carrier arrangement against rotation;
a first clutch configured to selectively couple two of the first sun wheel, the first planet carrier arrangement, and the first annulus to one another;
a third clutch configured to selectively couple the input element to the common third sun wheel; and
a fourth clutch configured to selectively couple the input element to the third annulus.

53. The multispeed transmission of claim 52, wherein
the first annulus is rigidly connected to the second sun wheel; and further comprising
a second brake configured to selectively hold the second annulus against rotation; and
a second clutch configured to selectively couple two of the second sun wheel, the second planet carrier arrangement, and the second annulus to one another.

54. The multispeed transmission of claim 52, wherein
the first annulus is rigidly connected to the second annulus; and further comprising
a second brake configured to selectively hold the second sun wheel against rotation; and
a second clutch configured to selectively couple two of the second sun wheel, the second planet carrier arrangement, and the second annulus to one another.
